(19) United States
(12) Patent Application Publication
(10) Pub. No.: US 2026/0265524 A1
(43) Pub. Date: Sep. 10, 2026

(54) BUILDING MATERIAL

(71) Applicant: POPLAC DEVELOPMENT S.L., Paterna (VALENCIA) (ES)

(72) Inventor: Asunción Ana BLASCO LAHIGUERA, Valencia (ES)

(21) Appl. No.: 18/847,021

(22) PCT Filed: Mar. 13, 2023
(86) PCT No.: PCT/EP2023/056313

§ 371 Date: Sep. 13, 2024

(30) Foreign Application Priority Data
Mar. 23, 2022 (ES) P202230262
Jul. 29, 2022 (EP) 22187705.3

(51) Int. Cl. C08L 97/00; C08K 3/26; C08K 5/09; C08K 11/00; C09K 3/10; E04C 2/16

(52) U.S. Cl. CPC C08L 97/00; C08K 3/26; C08K 5/09; C08K 11/005; C09K 3/1015; E04C 2/16; C08K 2003/262; C08K 2003/265; C08K 2201/014; C08L 2205/025; C08L 2205/03; C08L 2205/035; C09K 2200/0602

(57) ABSTRACT

A building material comprising crushed dead algae or aquatic plants and a binder of plant origin, characterized in that it comprises an aqueous solution of an organic acid. The use of an aqueous solution of an organic acid improves the mechanical properties of the material and, on the other hand, acts as an antimicrobial agent. The building material can be used to manufacture prefabricated parts for modular buildings or as biocement to seal joints and fixative.

### FIELD OF THE INVENTION

The present invention belongs to the technical field of new building materials. More specifically, it describes a building material with thermal, acoustic and fire-retardant insulation properties comprising algae or crushed dead aquatic plants, a vegetable binder and an aqueous solution of an organic acid.

### BACKGROUND OF THE INVENTION

Sustainable building materials are recycled or are those that can be recovered or recycled and are not harmful to the environment. These materials must have good energy efficiency, long life and also have adequate properties for different uses in building. The materials used in building must be fireproof, acoustic and/or thermal insulators, in addition to having high mechanical resistance and low density.

In general, seaweeds have very interesting building characteristics, since they can be used as insulating material without the need to go through complex industrial processes, and even without the use of chemical products.

The Fraunhofer Institute (Germany) has carried out several studies on cleaning (removing remains of sand, stones and other debris) and dismemberment of the remains of the Posidonia seaweed to form fibers for the manufacture of building panels. Tests showed that these fibers were able to store 20% more energy than wood, making them a highly effective natural thermal and acoustic insulating material. However, to achieve the dimensional stability of materials based on this type of algae, the addition of binders or additives is necessary.

EP1944423A2 describes the use of Posidonia oceanica fibers together with a suitable inorganic and organic binder, such as plaster (calcium sulfate), cement, aluminum and silicon oxide/dioxide, lime (calcium carbonate), soluble glass, phosphate binder or synthetic resin binder, as an insulating material in building products. However, this document does not detail the mechanical properties of the products and also uses binders that are not very compatible with the environmental purpose of reusing algae.

ES2538576 A1 describes a method for manufacturing panels made from 60-80% residual fibers of Posidonia oceanica, 20-40% thermoplastic fibers (specifically polylactic acid) and between 0-40% natural fibers (specifically hemp, sisal, flax or cotton fibers) by hot compression. However, the method of manufacturing such panels requires high temperatures and pressures, which make the method expensive due to the amount of resources used.

EP2840196A1 describes a process for the production of a thermoacoustic insulating plate comprising Posidonia and a mixture of diluted vegetable starch. However, this document does not detail the mechanical properties of the product obtained and the production process takes a long time, since the seaweed needs a maturation of 3 months and a formwork of at least 2 days.

Therefore, there is a need to find building materials that are sustainable and that take advantage of residues such as Posidonia algae, that do not include toxic or environmentally harmful compounds in their formulation, that are simple to obtain, that do not require a high consumption of resources and that also have acceptable or improved properties for use in building.

### DESCRIPTION OF THE INVENTION

The present invention solves the problems in the state of the art by providing a building material with improved mechanical properties, and which reduces the manufacturing time of some products, such as insulating panels made of this material, to a one day.

The building material of the present invention has a lower density than cement, but exhibits excellent mechanical properties, so it could be used as cement, more specifically as a biocement.

In addition, the use of this material as an alternative to cement provides the advantage of reducing energy consumption in the manufacture of cement.

The solution found by the inventors is a building material that is a good thermal, acoustic and fire-retardant insulator that comprises crushed dead aquatic plants, a binder of vegetable origin together with an aqueous solution of an organic acid. The acid donates protons and the water acts as a pH regulator.

The use of an aqueous solution of an organic acid improves the mechanical properties of the material and, on the other hand, acts as an antimicrobial agent. Therefore, the material does not include toxic materials that can generate dangerous leachates, or petroleum derivatives. It is, therefore, an ideal material to implement the circular and sustainable economy in the building sector.

In a first aspect, the invention relates to a building material comprising crushed dead algae or aquatic plants and a binder of plant origin, characterized in that it comprises an aqueous solution of an organic acid.

The aqueous solution of an organic acid may be generated from lactic acid, acetic acid, fumaric acid, glycolic acid, citric acid, malic acid or formic acid. In a preferred mode, the acid is acetic acid. The source of acetic acid can be glacial acetic acid or vinegars, which are diluted to a pH of 4-5.5. Reducing the pH of the mixture reduces microbial load, prevents algae decomposition and prevents generation of bad odors.

The algae or aquatic plants are collected dead on the shores of beaches and are later crushed. In a preferred mode, the algae or aquatic plants are selected from Posidonia oceanica, sargassum or Rugulopterix okamurae.

In a preferred mode, the crushed dead algae or aquatic plants are 1-5 mm in size. Sizes smaller than 1 mm reduce compressive strength, while sizes larger than 5 mm generate curved materials.

The binder of vegetable origin comprises polysaccharides, preferably starch and more preferably corn, cassava or wheat starch.

In a particular embodiment, the building material of the present invention comprises reinforcing agents, water-repellent agents, plasticizing agents, fire-retardant agents, or mixtures thereof.

In a preferred mode, the flame retardant agent is potassium bicarbonate.

In a preferred mode, the reinforcing agent is calcium carbonate.

In a preferred mode, the plasticizing agent is polycaprolactone, which also improves flexing properties.

In another particular embodiment, the building material of the present invention comprises of dried crushed Posidonia oceanica with a size of 1-5 mm, wheat starch, an aqueous solution of acetic acid with pH 4-5.5, potassium bicarbonate, calcium carbonate and polycaprolactone.

In another particular embodiment, the building material of the present invention comprises 16-18% of dried crushed Posidonia oceanica crushed with a size of 1-5 mm, 10-20% of starch, 1-10% of aqueous solution of acetic acid with pH 4.6, 2-20% of potassium bicarbonate, 8-25% of calcium carbonate, 3-5% of polycaprolactone and 35-60% of water. All the detailed percentages are expressed in weight/weight.

In a particular embodiment, the building material may comprise:
sludge, obtained from sewage sludge that reduces density, improves thermal insulation and increases compressive strength,
ash, which improves compressive strength,
sawdust, obtained from plant biomass,
corks to increase sound insulation, and/or
foaming agents to reduce density.

The building material of the present invention has a compressive strength of more than 10 MPa, a flexural strength of more than 3.0 MPa, and a tensile strength of more than 5.0 MPa.

The properties obtained for the materials of the present invention were:
Density: 200 kg/m³-1.000 kg/m³ depending on the amount of calcium carbonate added and the pressing.
Stability to fire: Flame retardant. A1 (Non-combustible)-s1 (Low opacity of the smoke produced)-d0 (Does not produce inflamed droplets or particles).
Behavior against water: Water repellent.
Thermal insulation: Thermal conductivity: less than 0.035 W/m*K with a thickness of 15 mm.
Acoustic insulation: measurements made on 4 cm thick walls result in internal noise of 62-71 dB and external noise of 114-117 dB within the frequency spectrum between 500-10,000 Hz.

The building material described in the invention is biodegradable but its mechanical properties are maintained for at least 50 years.

In another aspect, the invention relates to a method of manufacturing a building material as defined above, comprising the steps of:
a) Screening, sifting, crushing algae or dry dead aquatic plants; and
b) mixing the crushed algae or aquatic plants with a binder of vegetable origin and an aqueous solution of an organic acid.

In a particular embodiment, the method of the present invention additionally comprises a subsequent step of compressing and drying the mixture from step b).

In a preferred mode, in the method of the present invention, the aqueous solution of organic acid is an aqueous solution of acetic acid, the algae or aquatic plants are selected from Posidonia oceanica, sargassum or Rugulopterix okamurae with a size of 1-3 mm and the vegetable-based binder is starch.

In another aspect, the invention relates to the use of a building material as defined above to manufacture prefabricated parts for modular buildings.

In the context of the present invention, a prefabricated part is understood as a material that has been manufactured in a location other than the location corresponding to its application or use. This prefabricated part can adopt different measures and forms to be able to carry out its assembly in the location of application or use. For example, this prefabricated part can be a plate or panel for interior divisions, false ceilings, partitions, etc.

The building material can be used to make sandwich panels. In a particular embodiment, the building material of the present invention comprises a cardboard layer/plate that covers at least one of the surfaces of the panel. Preferably, at least two surfaces or faces of the panel, so as to form a sandwich-type panel.

In another aspect, the invention relates to the use of a building material as defined above as a biocement to seal joints and as a fixative.

The material of the present invention allows the use of typical cement setting accelerators, such as sodium acetate, sodium bicarbonate, sodium carbonate or mixtures of them. Their addition allows sealing the material against water permeability by accelerating the setting process.

In the context of the present invention, “biocement” is understood as a cement of natural origin with the characteristics of cement.

### DESCRIPTION OF EMBODIMENT METHODS

### Example 1. Manufacturing Method of a Material of the Present Invention

Initially, dead Posidonia oceanica leaves with a size between 1-5 mm were dried, screened, sieved and crushed. Leaves were then mixed with wheat starch and a solution of acetic acid (pH 4.6 dilution of wine vinegar in water). Finally, the mixture was conditioned in hermetic containers, controlling humidity.

The material obtained can be used as biocement.

### Example 2. Properties of the Material of the Present Invention

Different samples of the material of the present invention were prepared using the same method described in example 1. The content of the components of each sample is detailed in Table 1.

TABLE 1
Composition of the samples of the material of the present
invention prepared in example 3

| | Sample No. | | | |
|---|---|---|---|---|
| Components (% by weight) | 1 | 2 | 3 | 4 |
| Posidonia Oceanica | 40 | 37 | 18 | 16 |
| Starch | 20 | 20 | 20 | 15 |
| Acetic acid aqueous solution | 40 | 40 | 40 | 38 |
| Polycaprolactone | 0 | 3 | 3 | 5 |
| Potassium bicarbonate | 0 | 0 | 7 | 6 |
| Calcium carbonate | 0 | 0 | 12 | 20 |

All the detailed percentages are expressed in weight/weight.

Measurements of density, compressive strength and flexural strength were made for each of the samples. The values obtained are shown in Table 2.

TABLE 2
Properties of the samples of the material of the present invention

| | Sample No. | | | |
|---|---|---|---|---|
| Properties | 1 | 2 | 3 | 4 |
| Density (Kg/m³) | 500 | 600 | 700 | 800 |
| Compression resistance | 6 | 10 | 14 | 18 |
| (MPa) | | | | |
| Flexural resistance (MPa) | — | — | — | 3 |

It is observed that the higher the density of the material, the higher the compressive strength obtained.

### Example 3. Building Material of the Present Invention Including Cork, Sludge and Soap

Cork, sludge and/or soap were added to sample 3 of example 2. The content of the components of each sample is detailed in Table 3.

TABLE 3
Composition of the samples of the material of the present invention

| | Sample No. | | | |
|---|---|---|---|---|
| Components (% by weight) | 5 | 6 | 7 | 8 |
| Composition of sample No. 3 | 80 | 80 | 80 | 70 |
| Cork | 20 | 0 | 0 | 10 |
| Sewage sludge | 0 | 20 | 0 | 10 |
| Foaming agent | 0 | 0 | 20 | 10 |

All the detailed percentages are expressed in weight/weight.

With respect to the reference sample 3, sample 5 showed greater acoustic insulation, sample 6 greater mechanical resistance and sample 8 lower density.

### Example 4. Manufacturing Method of a Prefabricated Insulating Panel

The material obtained in example 1 was placed in molds and pressed at 20 KN, obtaining an insulating panel. The insulating panel was then dried in a convection-microwave oven and finally demolded and palletized.

### Example 5. Manufacture of Sandwich Panels

The panel obtained in example 4 was covered with cardboard plates on both surfaces and used to make partitions. Said panel was pierced with a drill and a weight of 30 kg was applied. It was observed that the panel did not deteriorate, showing great resistance.

### Example 6. Manufacture of a Biocement from the Panels

The panel described in example 4 was crushed and stored in hermetic bags, in which the amount of water required to manufacture the biocement is indicated. The biocement obtained has the same properties and composition as the biocement obtained in example 1 and whose characteristics are presented in example 2. Therefore, the material of the present invention can be considered reversible.

1. A building material comprising crushed dead algae or aquatic plants, a binder of vegetable origin, and an aqueous solution of an organic acid.

2. The building material according to claim 1, wherein the aqueous organic acid solution is an aqueous acetic acid solution.

3. The building material according to claim 1, wherein the algae or aquatic plants are selected from Posidonia oceanica, sargassum or Rugulopterix okamurae.

4. The building material according to claim 1, wherein the crushed dead algae or aquatic plants have a size of 1-3 mm.

5. The building material according to claim 1, wherein the binder of plant origin is starch.

6. The building material according to claim 1, further comprising reinforcing agents, water-repellent agents, plasticizing agents, fire-retardant agents or mixtures thereof.

7. The building material according to claim 1, wherein the building material comprises:
dried crushed Posidonia oceanica with a size of 1-3 mm;
wheat starch;
aqueous solution of acetic acid with pH 4-5.5;
potassium bicarbonate;
calcium carbonate; and
polycaprolactone.

8. The building material according to claim 7, wherein the building material comprises:
16-18% by weight of dried crushed Posidonia oceanica with a size of 1-5 mm;
10-20% by weight of starch;
1-10% by weight of aqueous solution of acetic acid with pH 4.6;
2-20% by weight of potassium bicarbonate;
8-25% by weight of calcium carbonate;
3-5% by weight of polycaprolactone; and
35-60% of water.

9. The building material according to claim 1, further comprising cork, sludge, ashes, sawdust, foaming agents or mixtures thereof.

10. A manufacturing method of a building material according to claim 1, comprising the following steps of:
a) drying, sifting, sieving and crushing algae or dead aquatic plants; and
b) mixing the crushed algae or aquatic plants with a binder of vegetable origin and an aqueous solution of an organic acid.

11. The manufacturing method according to claim 10, wherein said method further comprises a subsequent step of compressing and drying the mixture of step b).

12. The manufacturing method according to claim 10, wherein the aqueous solution of organic acid is an aqueous solution of acetic acid, the algae or crushed dead aquatic plants are selected from Posidonia oceanica, sargassum or Rugulopterix okamurae with a size of 1-5 mm and the binder of vegetable origin is starch.

13. A building material obtained by the method according to claim 11, wherein the material has a mechanical resistance to compression greater than 10 MPa and a resistance to bending greater than 3 MPa.

14. A prefabricated part for modular building comprising the building material according to claim 1.

15. A biocement to seal joints and fixative comprising the building material according to claim 1.
